(19) United States
(12) Patent Application Publication
(10) Pub. No.: US 2010/0060528 A1
(43) Pub. Date: Mar. 11, 2010

(54) DUAL-FREQUENCY ANTENNA

(75) Inventors: Tsung-Wen Chiu, Taipei County (TW); Hung-Chi Chang, Taipei County (TW); Wen-His Lee, Taipei County (TW); Fu-Ren Hsiao, Taipei County (TW)

Correspondence Address: SCHMEISER OLSEN & WATTS, 18 E UNIVERSITY DRIVE, SUITE # 101, MESA, AZ, 85201, US

(73) Assignee: ADVANCED CONNECTEK INC., Taipei County (TW)

(21) Appl. No.: 12/253,167

(22) Filed: Oct. 16, 2008

(30) Foreign Application Priority Data
Sep. 5, 2008 (TW) 097134186

(51) Int. Cl. H01Q 1/38

(52) U.S. Cl. 343/700 MS

(57) ABSTRACT

The present invention discloses a dual-frequency antenna, which comprises a radiation conductor, an extension conductor, a feeder member, a short-circuit member, and a ground plane. The radiation conductor has a first terminal and a second terminal, which are arranged close to each other but do not contact each other. The extension conductor is connected to the second terminal and disposed along the contour of the first terminal to have a gap between the extension conductor and the first terminal. The feeder member is connected to the radiation conductor. One end of the short-circuit member is connected to the radiation conductor, and the other end is connected to the ground plane. The radiation conductor generates a low-frequency resonant mode and a first high-frequency resonant mode. In the present invention, a single radiation conductor generates two resonant modes to form the operational frequency bands of the dual-frequency antenna.

### BACKGROUND OF THE INVENTION

1. Field of the Invention

The present invention relates to a dual-frequency antenna, particularly to an antenna structure, which uses a single radiation conductor to generate the operational frequency bands of a dual-frequency antenna system.

2. Description of the Related Art

The antenna is an essential element for all wireless communication devices. Recently, it has been a trend to equip wireless communication devices with a small, slim and lightweight antenna. However, structure miniaturization usually degrades the performance thereof. Because of intrinsic physical characteristics of an antenna, antenna miniaturization usually results in insufficient gain and inferior bandwidth. Thus, improving gain and bandwidth becomes an important task in miniaturization of the antenna. A dual-frequency antenna is a type of miniature antenna formed via appropriately layouting radiation elements to generate two resonant frequencies without increasing volume. Such a design is equivalent to the combination of two single-frequency antennae.

The conventional dual-frequency antenna uses two resonant paths to generate two operational frequency bands. Referring to FIG. 1, a top view of a dual-frequency antenna for a WLAN (Wireless Local Area Network) device was disclosed by a U.S. Pat. No. 7,057,560. The conventional dual-frequency antenna 100 is integrated with a wireless network card and comprises a baseplate 110, a printed PIFA (Planar Inverted-F Antenna) 130 supported by the baseplate 110, and a printed monopole antenna 170 supported by the baseplate 110. The printed PIFA 130 further comprises a radiation conductor 135, a feeder cable 140, a ground plane 120, and a ground line 160. The radiator conductor 135 is tuned to generate resonance within a first frequency band of 2.4-2.5 GHz. The monopole antenna 170 is connected to the feeder cable 140 and tuned to generate resonance within a second frequency band of 5.2-5.8 GHz.

Referring to FIG. 2, a top perspective view of a multi-frequency integration antenna for a notebook computer was disclosed by a Taiwan patent No. 1266451. The conventional multi-frequency integration antenna 2 comprises a baseplate 21, a first radiation metal trace 22, a second radiation metal trace 23, a ground metal plate 24, a first connection metal trace 25, a second connection metal trace 26, a feeder point 27 and a ground point 28. The first radiation metal trace 22 is formed on a first surface 211 of the baseplate 21, and generates a low-frequency first resonant mode. The second radiation metal trace 23 is arranged parallel to the first radiation metal trace 21 with an appropriate spacing therebetween, and generates a high-frequency second resonant mode.

However, the design of two radiation paths has a more complicated structure. The inappropriate configuration of the radiation elements thereof may cause insufficient bandwidth and poor matching. Further, the antenna volume is hard to reduce. Thus, such a design is harder to fabricate and has higher fabrication cost and lower yield.

### SUMMARY OF THE INVENTION

One objective of the present invention is to provide a dual-frequency antenna, wherein a radiation conductor generates a low-frequency resonant mode and a first high-frequency resonant mode, and an extension conductor modulates the operational frequencies of the low-frequency resonant mode and the first high-frequency resonant mode, whereby a single radiation conductor can generate two resonant modes to realize a dual-frequency antenna having two operational frequency bands.

Another objective of the present invention is to provide a dual-frequency antenna, wherein the radiation conductor thereof has a simple structure and is exempted from too much bending or machining in fabrication, whereby the assembling time is shortened and the yield is promoted, and whereby the present invention is easy to integrate with various wireless communication devices.

A further objective of the present invention is to provide a dual-frequency antenna, wherein a parasitic conductor connecting with the radiation conductor generates a second high-frequency resonant mode to increase the transmission bandwidth of the high-frequency frequency band and solve the problem that conventional dual-frequency antennae have insufficient bandwidth and inferior matching.

To achieve the abovementioned objectives, the present proposes a dual-frequency antenna, which comprises a radiation conductor, an extension conductor, a feeder member, a short-circuit member, and a ground plane. The radiation conductor has a first terminal and a second terminal, which are arranged close to each other but do not contact each other. The extension conductor is connected to the second terminal and disposed along the contour of first terminal to have a gap between the extension conductor and the first terminal. The feeder member is connected to the radiation conductor. One end of the short-circuit member is connected to the radiation conductor, and the other end is connected to the ground plane.

In a first embodiment of the present invention, the radiation conductor generates a low-frequency resonant mode and a first high-frequency resonant mode, which are the front two resonant modes of the antenna system and respectively the fundamental mode and the first high-order mode of the antenna system. In the present invention, a single radiation conductor generates two resonant modes to form the operational frequency bands of the dual-frequency antenna. The extension conductor extends from the second terminal. The gap between the extension conductor and the first terminal generates a capacitive coupling effect. Appropriately adjusting the gap can vary the imaginary impedance of the antenna system to make the operational frequencies of the low-frequency resonant mode and the first high-frequency resonant mode move to the desired operational frequency bands, whereby the two modes can have a superior impedance matching, and the operational bandwidth is also increased. Further, the radiation conductor has a simple structure and is exempted from too much bending or machining in fabrication. Therefore, the assembling time is shortened, and the yield is promoted. Furthermore, the present invention is thus easy to integrate with various wireless communication devices.

A second embodiment of the present invention is fundamentally similar to the first embodiment. However, the second embodiment is different from the first embodiment in that a parasitic conductor is connected to the radiation conductor and extends away from the extension conductor. The parasitic conductor generates a second high-frequency resonant mode to increase the transmission bandwidth of the high-frequency frequency band. Thus is achieved antenna miniaturization and operational bandwidth expansion.

Below, the embodiments are described in detail to make easily understood the technical contents of the present invention.

### BRIEF DESCRIPTION OF THE DRAWINGS

FIG. 1 is a top view of a dual-frequency antenna for a WLAN device disclosed by a U.S. Pat. No. 7,057,560;

FIG. 2 is a top perspective view of a multi-frequency integration antenna for a notebook computer disclosed by a Taiwan patent No. 1266451;

FIG. 3 is a top view schematically showing a first embodiment of the present invention;

FIG. 4 is a top view schematically showing a variation of the first embodiment of the present invention;

FIG. 5 is a diagram showing VSWR (Voltage Standing Wave Ratio) measurement results of the dual-frequency antenna according to the first embodiment of the present invention;

FIG. 6 is a top view schematically showing a second embodiment of the present invention;

FIG. 7 is a diagram showing VSWR (Voltage Standing Wave Ratio) measurement results of the dual-frequency antenna according to the second embodiment of the present invention; and

FIG. 8 is a partially-enlarged perspective view schematically showing that the second embodiment of the present invention is applied to a notebook computer.

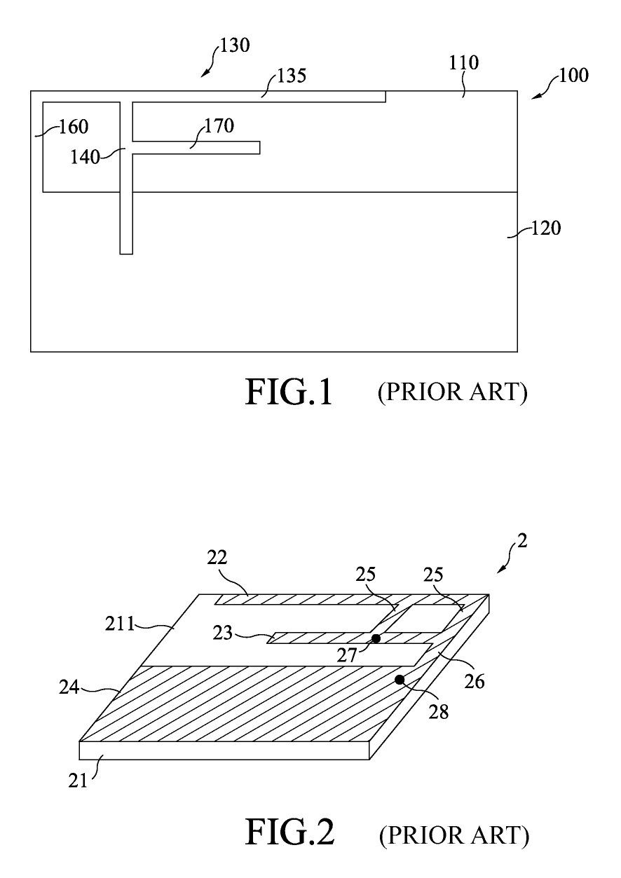

### DETAILED DESCRIPTION OF THE INVENTION

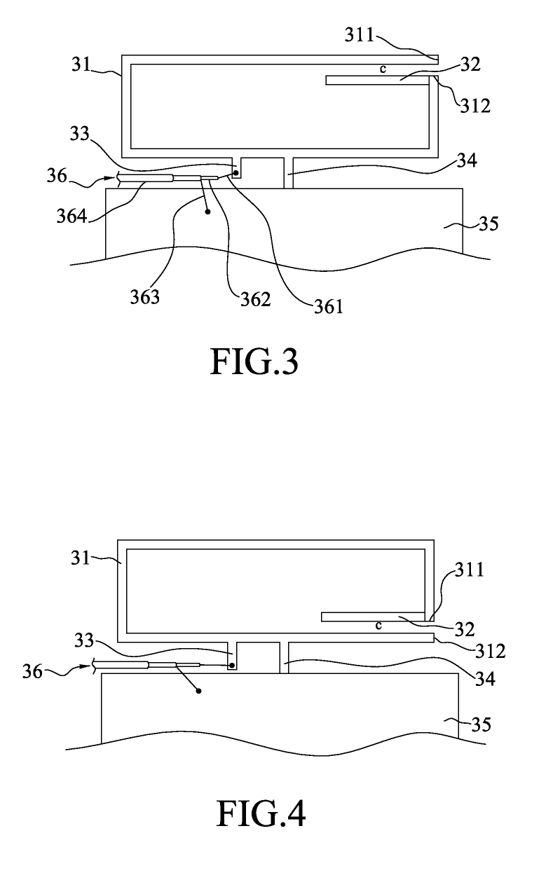

Referring to FIG. 3, a top view schematically shows a first embodiment of the present invention. The dual-frequency antenna of the present invention comprises a radiation conductor 31, an extension conductor 32, a feeder member 33, a short-circuit member 34, a ground plane 35, and a feeder cable 36. The radiation conductor 31 has a first terminal 311 and a second terminal 312. The feeder cable 36 further comprises a central wire 361, an insulating layer 362, an outer wire 363 and a coating 364 in sequence.

The radiation conductor 31 resembles a C shape. The first terminal 311 and the second terminal 312 of the radiation conductor 31 are arranged close to each other but do not contact each other. The extension conductor 32 is connected to the second terminal 312 and disposed along the contour of the first terminal 311 to have a gap C between the extension conductor 32 and the first terminal 311, and the gap C generates a capacitive coupling effect to increase the radiation transmission efficiency of the radiation conductor 31. The feeder member 33 is connected to the radiation conductor 31. One end of the short-circuit member 34 is connected to the radiation conductor 31, and the other end is connected to the ground plane 35. The central wire 361 of the feeder cable 36 is connected to the feeder member 33 and transmits the high-frequency transmission signal of the feeder cable 36 to the feeder member 33. The outer wire 363 of the feeder cable 36 is connected to the ground plane 35.

Each of the upper and lower rectangular areas of the radiation conductor 31 has a length of about 45 mm and a width of about 2 mm. Each of the left and right rectangular areas of the radiation conductor 31 has a length of about 8 mm and a width of 4 mm. The extension conductor 32 has a length of about 17 mm and a width of about 2 mm. The feeder member 33 has a length of about 2 mm and a width of about 1.5 mm. The short-circuit member 34 has a length of about 4 mm and a width of about 2 mm.

In the first embodiment, the radiation conductor 31 generates a low-frequency resonant mode and a first high-frequency resonant mode, which are the front two resonant modes of the antenna system and respectively the fundamental mode and the first high-order mode of the antenna system. The C-shape radiation conductor 31 has a first terminal 311 and a second terminal 312, and the extension conductor 32 extends from the second terminal 312. The gap C between the extension conductor 32 and the first terminal 311 generates a capacitive coupling effect. Appropriately adjusting the gap C can vary the imaginary impedance of the antenna system to make the operational frequencies of the low-frequency resonant mode and the first high-frequency resonant mode move to the desired operational frequency bands, whereby the two modes can have a superior impedance matching, and the operational bandwidth is also increased. Therefore, the present invention can use a single radiation conductor 31 to generate two resonant modes and use the terminals of the C-shape radiation conductor 31 to generate a capacitive coupling effect. Further, the present invention simplifies the structure of the radiation conductor 31, shortens the fabrication process and favors mass production.

Referring to FIG. 4, a top view schematically shows a variation of the first embodiment of the present invention. In FIG. 4, the extension conductor 32 is connected to the first terminal 311 of the radiation conductor 31 and disposed along the contour of the second terminal 312 to form a gap C between the extension conductor 32 and the second terminal 312. The gap C can generate a capacitive coupling to increase the radiation transmission efficiency of the radiation conductor 31.

As described above, the present invention adopts the C-shape radiation conductor 31, and the radiation conductor 31 has the first terminal 311 and the second terminal 312, which are arranged close to each other but do not contact each other. Thus, no matter the extension conductor 32 is connected to the first terminal 311 or the second terminal 312, the extension conductor 32 is always disposed along the contour of the other terminal to form a gap C between the extension conductor 32 and the other terminal.

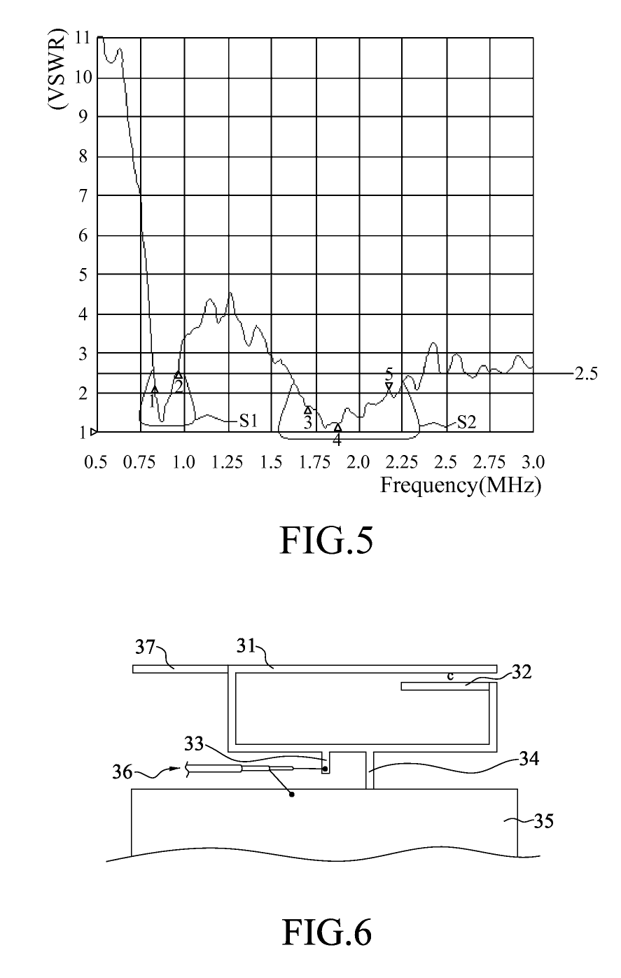

Referring to FIG. 5, a diagram shows VSWR (Voltage Standing Wave Ratio) measurement results of the dual-frequency antenna according to the first embodiment of the present invention. When a bandwidth S1 and a bandwidth S2 are defined by a voltage standing wave ratio of 2.5, the bandwidth S1 ranges from 824 MHz to 960 MHz, which covers the AMPS system (824-894 MHz) and GSM system (880-960 MHz), and the operation frequency of the bandwidth S2 ranges between 1575 and 2250 MHz, and the frequency band covers the GPS system (1575 MHz), DCS system (1710-1880 MHz), PCS system (1850-1990 MHz) and UMTS system (1920-2170 MHz). From the measurement results, it is known that the present invention indeed have better operational frequency bands and impedance matching.

Referring to FIG. 6, a top view schematically shows a second embodiment of the present invention. The second embodiment is fundamentally similar to the first embodiment, and the identical or equivalent elements are designated with the same numerals. The second embodiment is different from the first embodiment in that a parasitic conductor 37 is connected to the radiation conductor 31 and extends away from the extension conductor 32.

In addition to the low-frequency resonant mode and the first high-frequency resonant mode generated by the radiation conductor 31, the parasitic conductor 37 generates a second high-frequency resonant mode in the second embodiment to increase the transmission bandwidth of the high-frequency frequency band. Thus, the present invention can improve the problem of insufficient bandwidth and inferior matching in the conventional dual-frequency.

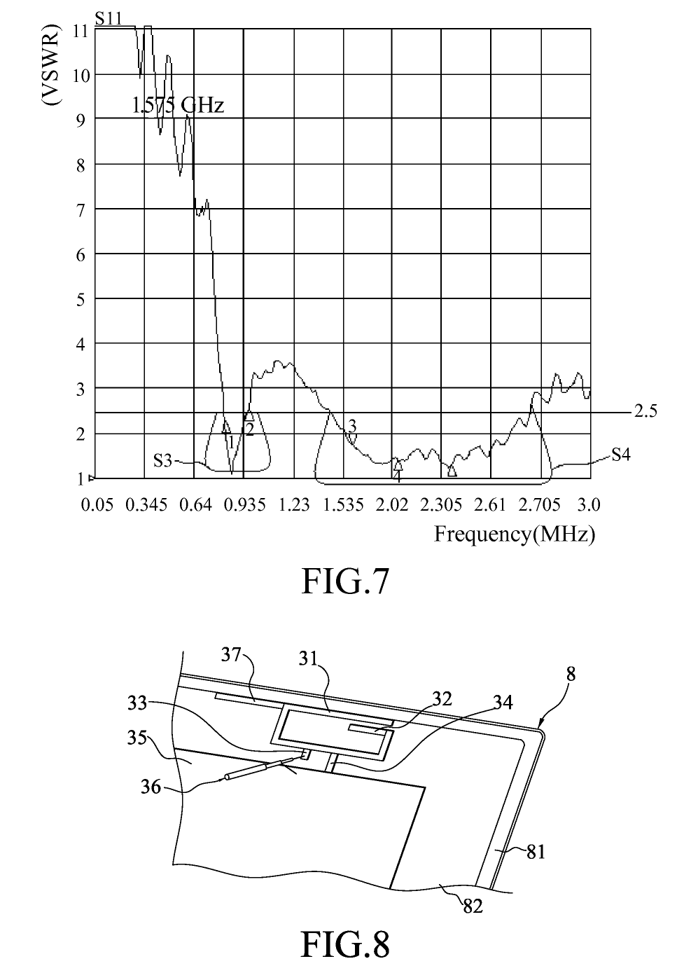

Referring to FIG. 7 a diagram shows VSWR (Voltage Standing Wave Ratio) measurement results of the dual-frequency antenna according to the second embodiment of the present invention. When a bandwidth S3 and a bandwidth S4 are defined by a voltage standing wave ratio of 2.5, the bandwidth S3 ranges from 800 MHz to 960 MHz, which covers the AMPS system (824-894 MHz) and GSM system (880-960 MHz), and the operation frequency of the bandwidth S4 ranges between 1400 and 2600 MHz, and the frequency band covers the GPS system (1575 MHz), DCS system (1710-1880 MHz), PCS system (1850-1990 MHz), UMTS system (1920-2170 MHz) and WLAN802.11b/g system (2400-2500 MHz). The measurement results show that the parasitic conductor increases the transmission bandwidth of the high-frequency frequency band, and that the present invention has better operational frequency bands and impedance matching.

Refer to FIG. 8, a partially-enlarged perspective view shows that the second embodiment of the present invention is applied to a notebook computer. In this application, the antenna of the present invention is integrated with a notebook computer 8. The radiation conductor 31 is attached onto a surface of a side plate 81 of the notebook computer 8. The ground plane 35 adopts a tin foil. The tin foil is attached onto a surface of a baseplate 82 of the notebook computer 8, and one edge of the tin foil is connected to the short-circuit member 34. Via the tin foil, the signal of the ground plane 35 is transmitted to the ground plane of the notebook computer 8.

From the above description, it is known that the present invention possesses utility, novelty and non-obviousness and meets the conditions for a patent. However, it is to be noted that the embodiments described above are only to exemplify the present invention but not to limit the scope of the present invention. Therefore, any equivalent modification or variation according to the spirit of the present invention is to be also included within the scope of the present invention.

What is claimed is:

1. A dual-frequency antenna comprising
a radiation conductor having a first terminal and a second terminal, which are arranged close to each other but do not contact each other;
an extension conductor connected to said second terminal and disposed along a contour of said first terminal to have a gap between said extension conductor and said first terminal;
a feeder member connected to said radiation conductor;
a short-circuit member with one end connected to said radiation conductor; and
a ground plane connected to another end of said short-circuit member.

2. The dual-frequency antenna according to claim 1 further comprising a feeder cable including
a central wire connected to said feeder member; and
an outer wire connected to said ground plane.

3. The dual-frequency antenna according to claim 1, wherein said radiation conductor resembles a C shape.

4. The dual-frequency antenna according to claim 1, wherein said radiation conductor generates a low-frequency resonant mode and a first high-frequency resonant mode.

5. The dual-frequency antenna according to claim 4, wherein said low-frequency resonant mode and said first high-frequency resonant mode generated by said radiation conductor are front two resonant modes of said antenna and respectively a fundamental mode and a first high-order mode.

6. The dual-frequency antenna according to claim 1, wherein said gap is used to adjust an imaginary impedance of said antenna.

7. A dual-frequency antenna comprising
a radiation conductor having a first terminal and a second terminal, which are arranged close to each other but do not contact each other;
an extension conductor connected to said second terminal and disposed along a contour of said first terminal to have a gap between said extension conductor and said first terminal;
a parasitic conductor connected to said radiation conductor and extending away from said extension conductor;
a feeder member connected to said radiation conductor;
a short-circuit member with one end connected to said radiation conductor; and
a ground plane connected to another end of said short-circuit member.

8. The dual-frequency antenna according to claim 7 further comprising a feeder cable including
a central wire connected to said feeder member; and
an outer wire connected to said ground plane.

9. The dual-frequency antenna according to claim 7, wherein said radiation conductor resembles a C shape.

10. The dual-frequency antenna according to claim 7, wherein said radiation conductor generates a low-frequency resonant mode and a first high-frequency resonant mode.

11. The dual-frequency antenna according to claim 10, wherein said low-frequency resonant mode and said first high-frequency resonant mode generated by said radiation conductor are front two resonant modes of said antenna and respectively a fundamental mode and a first high-order mode.

12. The dual-frequency antenna according to claim 7, wherein said gap is used to adjust an imaginary impedance of said antenna.

13. The dual-frequency antenna according to claim 7, wherein said parasitic conductor generates a second high-frequency resonant mode.
